(19) United States
(12) Patent Application Publication
(10) Pub. No.: US 2024/0210587 A1
(43) Pub. Date: Jun. 27, 2024

(54) A STARTING MODEL INDEPENDENT FULL WAVEFORM INVERSION SYSTEM, METHOD, AND COMPUTER-PROGRAM PRODUCT FOR SUBSURFACE VELOCITY ESTIMATION

(71) Applicant: BOARD OF REGENTS, THE UNIVERSITY OF TEXAS SYSTEM, Austin, TX (US)

(72) Inventors: Zeyu ZHAO, Austin, TX (US); Mrinal K. SEN, Austin, TX (US)

(21) Appl. No.: 18/286,176

(22) PCT Filed: Apr. 11, 2022
(86) PCT No.: PCT/US2022/024235

§ 371 Date: Oct. 9, 2023

Related U.S. Application Data
(60) Provisional application No. 63/173,715, filed on Apr. 12, 2021.

(51) Int. Cl. G01V 1/30; G01V 1/28

(52) U.S. Cl. CPC G01V 1/303; G01V 1/282; G01V 2210/48; G01V 2210/614; G01V 2210/6161; G01V 2210/67

(57) ABSTRACT

Disclosed herein are systems, methods, and computer-program product to directly estimate subsurface properties from seismic data acquired on the surface or in the well bore hole without user provided specific starting models using full waveform inversion (FWI) techniques. The inversion result provides accurate subsurface properties estimation and such estimation is independent to the starting model.

### CROSS REFERENCE TO RELATED APPLICATION

This application claims priority to and benefit of U.S. provisional patent application 63/173,715 filed Apr. 12, 2021, which is fully incorporated by reference and made a part hereof.

### BACKGROUND

Seismic full waveform inversion (FWI) is one of the most attractive seismic imaging tools for estimating subsurface fluid and rock properties by taking most, if not all types, of seismic waves into account. By iteratively fitting both the kinematic and the dynamic of the observed seismic data, FWI is able to build high-resolution subsurface models. Due to the highly nonlinear parameter to data mapping, there are multiple local minima in the parameter space. Traditional FWI based on a local optimization method might fail to converge to a geologically meaningful model if the starting model of the inversion does not contain sufficiently accurate macro-structures.

Early developments of the theory of FWI are reported in the papers by Lailly (1983) and Tarantola (1984). Its application, primarily in the acoustic formulation for estimating subsurface parameters, has now become a part of seismic processing sequence. In FWI, both the kinematic and the dynamic characteristics of the seismic waves are utilized by matching the observed data with the estimated data generated with a trial subsurface model. This results in high spatial resolution subsurface parameter estimations compared to travel-time-based tomographic inversion methods, where only travel-time information is exploited. A detailed review of FWI can be found in Virieux and Operto (2009).

To measure the accuracy of an estimated model with respect to the true model, a certain objective function that measures the misfit between the observed data and the estimated data is usually introduced. By minimizing the objective function, one hopes to recover an optimal model that better explains the observed data than the starting model. A widely used objective function is the L2 norm, which measures the least-squares misfit, and FWI is often formulated into the local optimization framework to reduce the data misfit in an iterative manner (Santosa et al., 1987; Pratt et al., 1998; Virieux and Operto, 2009). Due to the oscillatory nature of seismic waveform and the highly nonlinear relationship between subsurface model parameters and seismic data, there are many local minima in the parameter space (Mulder and Plessix, 2008). Although local optimization algorithms can efficiently converge to a nearby minimum, the inversion result is not guaranteed to be a geologically meaningful solution. Traditional FWI algorithms based on the L2 norm misfit function are known to be sensitive to the choice of starting model, and they are particularly prone to converge to a local minimum. This often results in the well-known ‘cycle-skipping’ phenomenon (Virieux and Operto, 2009), which is one of the major bottlenecks of successfully implementing FWI to field datasets.

The ‘cycle-skipping’ issue recently augmented many developments in FWI. Such efforts include relying on new objective functions that are more convex so that local optimization methods can still generate reasonable results (Tape et al., 2010; Wu et al., 2014; Warner and Guasch, 2016; Zhu and Fomel, 2016; Engquist and Froese, 2013; M'etivier et al., 2016). Others try to formulate FWI into a multi-scale fashion to recover low wavenumber macro-structures before adding high wavenumber details (Bunks et al., 1995; Shipp and Singh, 2002; Sirgue and Pratt, 2004; Ravaut et al., 2004; Xue et al., 2016; Zhao and Sen, 2019). Additionally, adding extra dimensions in the parameter space is also explored to better constrain the inversion (Symes, 2008; Biondi and Almomin, 2014). All of these novel strategies are able to relax the dependence of FWI on the choice of the starting model, which improves the robustness of FWI.

Unlike local optimization algorithms, global optimization methods are able to move around the parameter space so that search for a solution is not restricted to be within a small local region. Theoretically, given sufficient iterations, a global optimization method can explore the parameter space, and is able to find a solution that is close to the region where the global solution resides. However, conventional global optimization methods are excessively computationally intensive in high dimensions.

Various global optimization methods have been successfully implemented for geophysical inverse problems (Sen and Stoffa 2013). Simulated annealing and its variant VFSA is one of the global optimization methods widely used in different applications (Sen and Stoffa, 1991, 2013). In the context of FWI, Datta and Sen (2016) recently proposed to build a starting model for local optimization based FWI with VFSA method. They showed that output of their sparsely parameterized VFSA FWI is able to provide a good background velocity model for subsequent local optimization based FWI. Due to the ‘curse of dimensionality’, most applications of global optimization methods to geophysical inverse problems are restricted to relatively low dimensions (Sambridge and Mosegaard, 2002). For realistic size 2D FWI problems where number of parameters can easily surpass tens of thousands, directly applying global optimization methods can be computationally prohibitive.

Therefore, systems and methods are desired that overcome challenges in the art, some of which are described above. In particular, an optimization method is desired that can generate an accurate background velocity model that is close to the true model. The optimization model creates final results that are not sensitive to the choice of the starting model, and is not excessively computationally intensive.

### SUMMARY

Described herein, a derivative-based local search step is added to a VFSA global optimization framework to provide a hybrid optimization method for FWI. The disclosed hybrid method comprises a gradient update, which guides the search to reduce data misfit, and a VFSA update, which helps the search to move around in the parameter space. Therefore, the search is not confined in a small region. By adding the gradient information into VFSA, the computational cost of the global optimization based FWI is greatly reduced, while at the same time tackle the issue of the presence of multiple local minima. The result of the disclosed hybrid optimization FWI is an accurate background model that can be utilized as the starting model for the subsequent local optimization FWI to further refine the model. 2D synthetic models are used herein to demonstrate the effectiveness of the disclosed method.

While Porsani et al. (1993) and Chunduru et al. (1997) have also explored the possibility to include local optimization methods into a global optimization workflow to reduce the computational cost of global optimization methods, they failed to contemplate how the gradient and the regularization terms are utilized in updating the model. In addition, the disclosed methods work on more challenging large-scale high dimensional seismic waveform inversion problem.

While this disclosure primarily describes FWI applied to subsurface mapping (including conventional/unconventional oil and gas exploration, onshore/offshore field, time-lapse subsurface monitoring, subsurface CO₂ storage monitoring, mineral exploration, tectonic study, and the like), the systems and methods described herein may also be applied to medical imaging (human body internal imaging), ultrasonic non-destructive testing, and/or any other disciplines that require solving the inverse problem.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIGS. 1A and 1B are exemplary illustrations of acquiring seismic data where FIG. 1A illustrates marine acquisition and FIG. 1B illustrates land acquisition.

FIG. 2 is an example of a seismic shot that may be acquired using the techniques shown in FIGS. 1A and 1B, or by other methods of acquiring seismic data.

FIGS. 3A, 3B and 3C illustrate an exemplary process diagram showing that FWI tries to iteratively minimize the difference between the seismic data (FIG. 3A) and synthetic data (FIG. 3B) that is generated from a wave simulator using an estimated starting model (FIG. 3C) of the subsurface.

FIG. 4 is a flowchart of an exemplary method of using the disclosed hybrid optimization FWI to estimate subsurface velocity.

FIG. 5 is an example of an overthrust true velocity model.

FIG. 6 left column shows five different starting models which include from top to the bottom: a smoothed version of the true velocity model, a constant velocity of v=2 km/s, a constant velocity of v=4.5 km/s and two random velocity models drawn from velocity range between 1.9 km/s and 6 km/s. FIG. 6 right column shows traditional local optimization FWI results with the starting models shown in the left column.

FIG. 7 left column shows results of the disclosed method. Figures from top to the bottom are the results corresponding to the constant v=2 km/s, v=4.5 km/s, and the two random drawn starting models, respectively. FIG. 7 right column shows the subsequent local optimization FWI results starting from the left column models smoothed with a Gaussian filter of σ=0.03 km.

FIG. 8 illustrates an example of a seam salt true velocity model.

FIGS. 9A and 9B show the starting model and the traditional local optimization FWI result, respectively.

FIG. 10A shows the result of the disclosed method, the overall background velocity model is retrieved, and FIG. 10B shows the subsequent local optimization based FWI starting from a slightly smoothed version of the model shown in 10A.

FIG. 11 is a block diagram illustrating an exemplary operating environment for performing the disclosed methods, according to one implementation.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

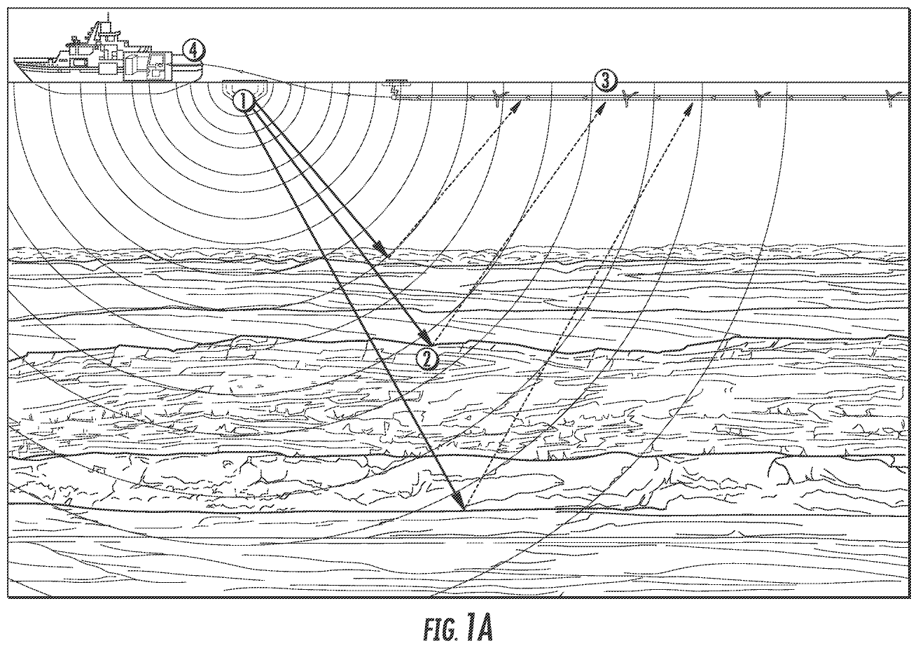

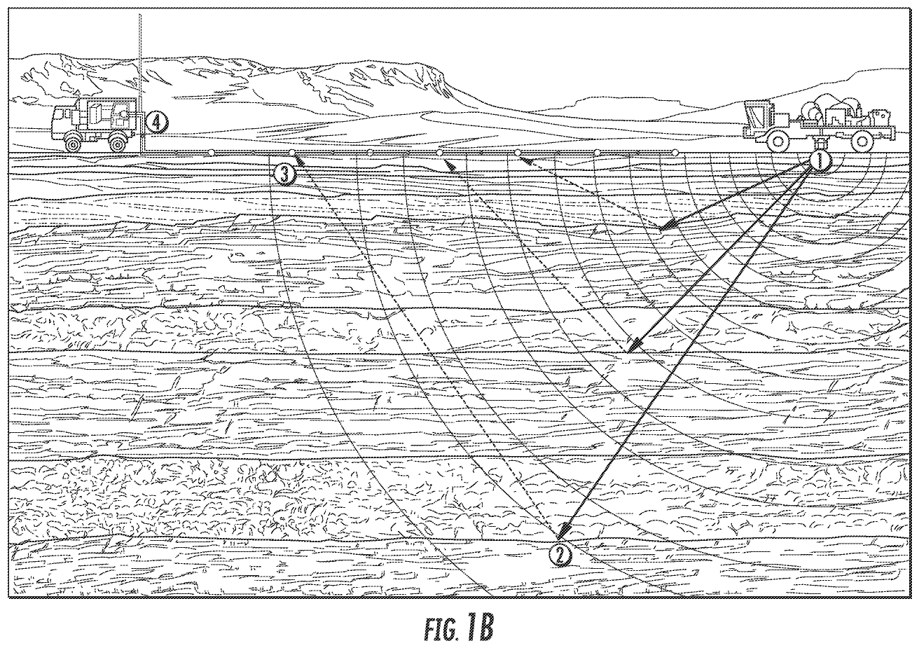

FIGS. 1A and 1B are exemplary illustrations of acquiring seismic data where FIG. 1A illustrates marine acquisition and FIG. 1B illustrates land acquisition. In each of FIGS. 1A and 1B, the process of acquiring seismic data comprise 1 emission of a controlled acoustic energy from a seismic source. For example, compressed air may be used as marine sources (marine), or a seismic vibrator or explosive source may be used of land acquisition. At 2, seismic energy is transmitted to the earth and reflected from the geological boundaries (layers). At 3, the reflected energy is detected by geophones (land) or hydrophones (marine). And, at 4, acquisition systems record and process the data.

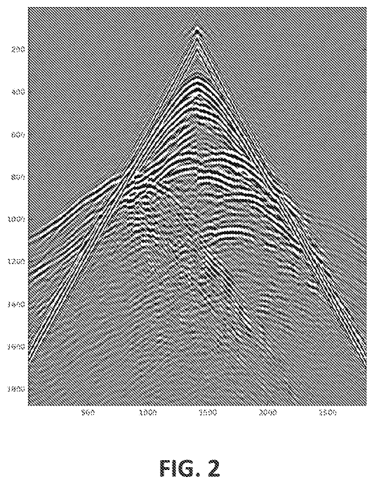

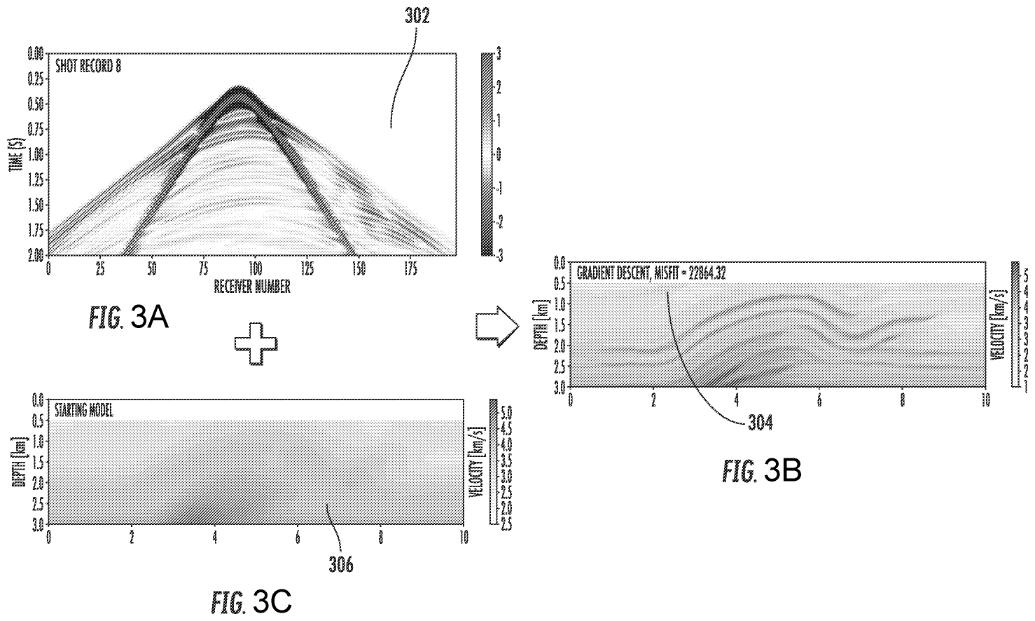

FIG. 2 is an example of a seismic shot that may be acquired using the techniques shown in FIGS. 1A and 1B, or by other methods of acquiring seismic data. As shown in FIGS. 3A, 3B and 3C, FWI tries to iteratively minimize the difference between the observed seismic data (e.g., FIG. 2) 302 and synthetic data 304 that is generated from a wave simulator using an estimated starting model 306 of the subsurface.

### Local Optimization Framework

The L2 norm objective function can be written as:

$$\\ \begin{matrix}E ( m ) = \frac{1}{2} {‖ {d}_{obs} - {d}_{est} ‖}_{2} , & ( 1 )\end{matrix}$$

where m is the model parameter, d_{obs} and dₑₛₜ represent the observed data and the estimated data, respectively. In FWI setting, the forward modeling f(m)=dₑₛₜ is a nonlinear mapping. In a typical local optimization framework, one seeks to reduce the data misfit by updating the model in the opposite direction to the gradient to reach the nearby stationary point. This can be achieved via

mₖ₊₁=mₖ−αg, (2)

where k represents iteration, α is the step length, g=∇mE(m) represents the gradient of E with respect to m. Equation 2 is widely used in the local optimization based FWI to update m in an iterative fashion. Although variants of equation 2 are employed to update the model, for instance conjugate gradient, Gaussian-Newton, Full Newton and quasi-Newton method, they share the same principle: always move in the downhill direction with the information solely provided by the derivatives of the misfit function.

### VFSA Framework

VFSA (Ingber, 1989) is a global optimization algorithm that draws an analogy between model parameters in an optimization problem and particles in an idealized physical system. VFSA simulates the evolution of the physical system as it cools to a state with minimum energy. VFSA algorithm has been found useful in variety of geophysical inverse problems (Sen and Stoffa, 2013; Mishra et al., 2020). VFSA algorithm can be described by

```
Algorithm 1. VFSA algorithm
Choose a random starting model m₀ and compute energy E(m₀)
Loop over temperature T according to a cooling schedule
    Loop over number of random moves within the temperature
    Loop over model parameters i = 1, . . . , Nₘ
      Draw random number uⱼ from U([0, 1])
      ${y}_{i} = sgn ( {u}_{i} - \frac{1}{2} ) {T}_{i}^{new} [ {( 1 + \frac{1}{{T}_{i}^{new}} )}^{\vert 2 {u}_{i} - 1 \vert} - 1 ]$
      mᵢ^{new} = mᵢ^{old} + yᵢ(mᵢ^{max} − mᵢ^{min})
      mⱼ^{min} ≤ mᵢ^{new} ≤ mᵢ^{max}
    end parameter loop with new model m^{new}
    ΔE = E(m^{new}) − E(m^{old})
    $P = exp ( - \frac{Δ E}{T} )$
    if ΔE ≤ 0, then
      m^{old} = m^{new}
      E(m^{old}) = E(m^{new})
    else
      draw a random number r from U([0, 1])
      if P > r
        m^{old} = m^{new}
      end if
    end if
  end loop
end loop
```

where T simulates the temperature of a cooling physical system. A too fast cooling schedule might lead to insufficiently exploring the parameter space, getting stuck at a local region. A too slow cooling schedule would make the optimization converge very slowly. So a tuning process is needed to find a proper cooling schedule for a specific problem. In high dimensional problems, VFSA requires a slow cooling schedule to ensure the convergence to the global solution by giving individual parameter enough time to drift to the low-energy region. As a result, in realistic size FWI applications with a large number of parameters, directly applying the VFSA method can be very computationally expensive.

### Hybrid Optimization Framework

Although VFSA algorithm is able to escape from local minima and it has a very nice convergence property, the computational cost of the algorithm can become substantially expensive for large scale FWI problems. The data misfit can wander at a very high level before gradually moving downhill. As disclosed herein, derivative information is combined with the VFSA model perturbation step to improve the ability of the parameter search process to drift to a lower data misfit state. The model update rule in Algorithm 1 is replaced with

mᵢ^{new}=mᵢ^{old}−αgᵢ+yᵢΔmᵢ+D(m)ᵢ, (3)

where α is the gradient update step length, gᵢ is the gradient of the ‘ith’ model parameter at the current iteration, Δmᵢ is the model perturbation range for the ‘ith’ parameter. In the new update rule, the model perturbation scaled by yᵢ is changed from m^{max}−m^{min}, which is the entire parameter searching interval, to Δmᵢ which is a predefined model perturbation range. A preconditioner, such as the approximate diagonal of the Hessian or even the full Hessian itself, can be applied to the gradient to balance the gradient contribution from different parameters. Further comprising Eq. 3 is the regularization term, D(m)ᵢ.

In this way, the gradient information is incorporated into the VFSA model update. Because the disclosed algorithm allows moving around the parameter space even if the next generated model has a worse data misfit, the inversion is not restricted in one valley of the misfit manifold as in the case of a local optimization method. Since the derivatives of the misfit function is considered in updating the parameters, the inversion tends to go to the direction where the data misfit can be reduced. Of note, the original VFSA algorithm only estimates objective function E(m), which only needs the forward calculation. While the disclosed hybrid optimization method requires computing the gradient term, which in general needs additional calculations. In FWI where adjoint-state method is widely used to compute the gradient, two wavefield calculations, one forward and one backward, are necessary for each shot in each iteration, which basically doubles the computational cost comparing to the original VFSA algorithm. However, the extra computational effort for obtaining the gradient can help reducing the number of iterations needed for a convergence, especially for cases with a large number of parameters.

Referring to the VFSA algorithm, above, application of the VFSA can be explained in the following steps:
1. Initiate seismic source at multiple locations
2. Record/receive seismic reflection and refraction signals from the subsurface
3. Pre-process recorded data by removing noises
4. Generate a simple starting model
5. Iteratively execute following steps
   a. Generate the current temperature Tₖ according to a user defined cooling schedule at the current iteration k, the temperature Tₖ is obtained with Tₖ=T₀exp(−c*k^{0.5}) where T₀ is the starting temperature and c is the temperature decay factor
      i. Estimate synthetic seismic data using seismic wave simulator by solving two-way wave equations for multiple source locations
      ii. Calculate objective function defined by

$$\\ E ( m ) = \frac{1}{2} {‖ {d}_{obs} - {d}_{est} ‖}_{2} ,$$

iii. Compute gradient of the objective function with respect to model parameter at each inversion grid (model parameter i) by solving two way wave equations for multiple source locations with multiple times using the adjoint-state method
iv. Loop over numbers of random moves within the current temperature:
   1. for each model parameter i
   a. Draw random number uᵢ from a uniform distribution ranging from [0 1]
   b. Get yᵢ according to the Table 1, above, yᵢ
   c. Update model parameter mᵢ using mᵢ(new)<=mᵢ(old)−α*gᵢ+yᵢ(Δm)+Dᵢ (where α is the step length, gᵢ is the gradient term, and Dᵢ is the regularization term)
   d. Decide if mᵢ(new) is within the range of mᵢ_max and mi_min, if so, continue to below 2., if not, go back to step a Draw random number. . . .
   2. Compute the difference between the objective function of the old model and the objective function of the new model, ΔE
   3. Compute P=exp(−ΔE/Tₖ), where Tₖ is the current temperature
   4. If ΔE<=0, then
   a. Accept the new model
   i. Replace the current model with the new model
   ii. Replace the current objective function with the new objective function
   iii. Replace the current gradient with the new gradient
   5. else if ΔE>0, then
   a. Draw a random number r from a uniform distribution ranging from [0 1]
   b. If P>r, then
   i. Accept the new model
   1. Replace the current model with the new model
   2. Replace the current objective function with the new objective function
   3. Replace the current gradient with the new gradient
   c. Else if P<=r, then
   i. Reject the new model
   1. Keep the current model
   2. Keep the current objective function
   3. Keep the current gradient
v. End the iterative loop of ‘iv’ if the numbers of random move within the current temperature is finished
b. End the iterative loop of ‘a’ if the cooling schedule reach the end or ΔE is smaller than a user defined value (the stopping criteria)
6. Output the final model for predicting subsurface structures.

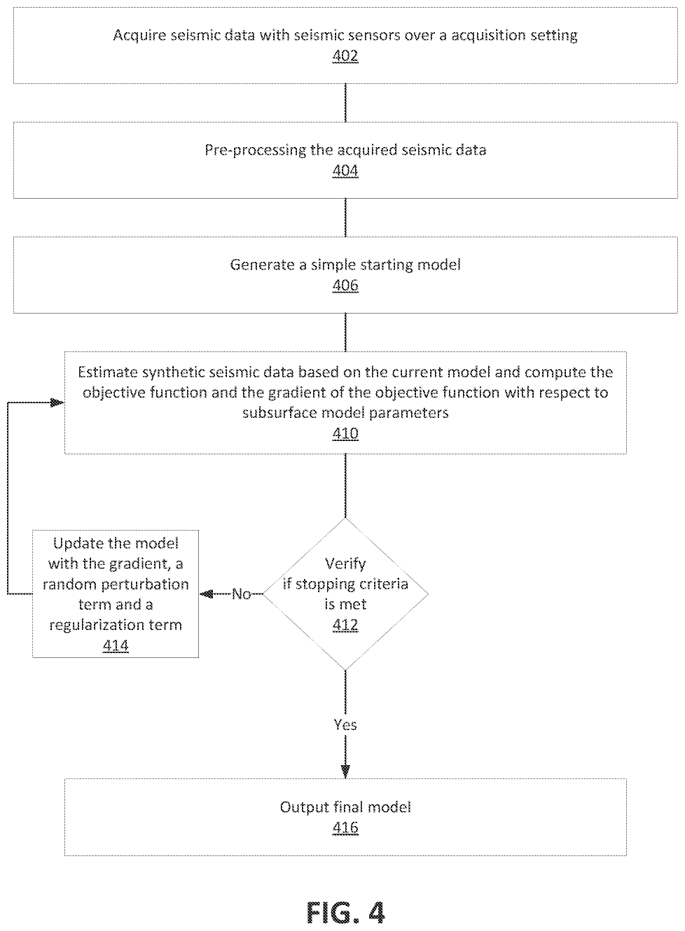

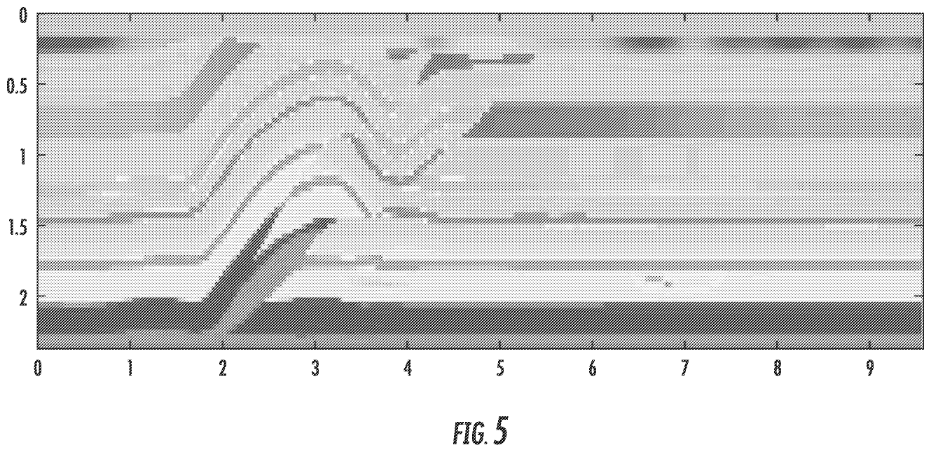

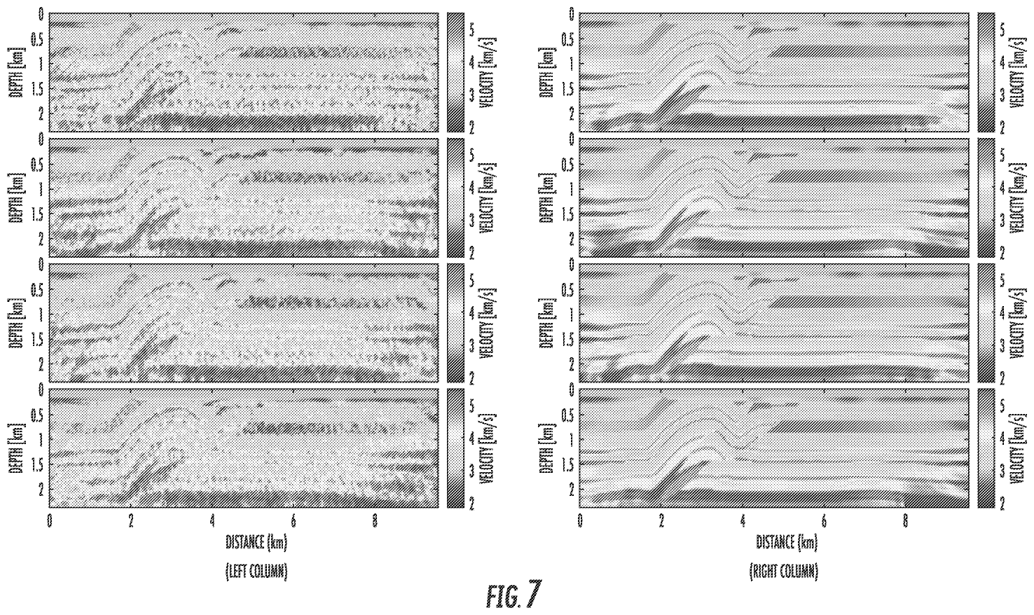

FIG. 4 is an illustration of an exemplary flowchart for implementing the above-described method. At step 402, seismic shot gathers seismic data are acquired from field surveys (see, for example, FIGS. 1A and 1B). At 404, the acquired seismic data is pre-processed to remove noises. At 406, a simple starting model is created. This can be any model. For example, the starting model may be a homogenous model or randomly generated model as shown in FIG. 6 left panels. Other staring models that may be considered include a model derived based on prior well-log information or a tomographic model. Step 410 comprises an iterative updating step. At 410, synthetic seismic data is generated based on the chosen starting model (i.e., current model). The objective function is computed by comparing the synthetic seismic data with pre-processed observed data. The gradient of the objective function with respect to subsurface model parameters is computed based on the current model. At 412, it is determined whether stopping criteria is met. The stopping criteria can be defined as a small mismatch value between the synthetic seismic data and the observed data or it can be the number of iterative updating steps. If the stopping criteria is not met, then at 414 the current model is updated with the computed gradient, a random perturbation term, and a regularization term, and the process returns to 410. If, at 412, it is determined that the stopping criteria is met, them the process goes to 416, where the process ends and the disclosed method provides a final subsurface model.

### Numerical Examples

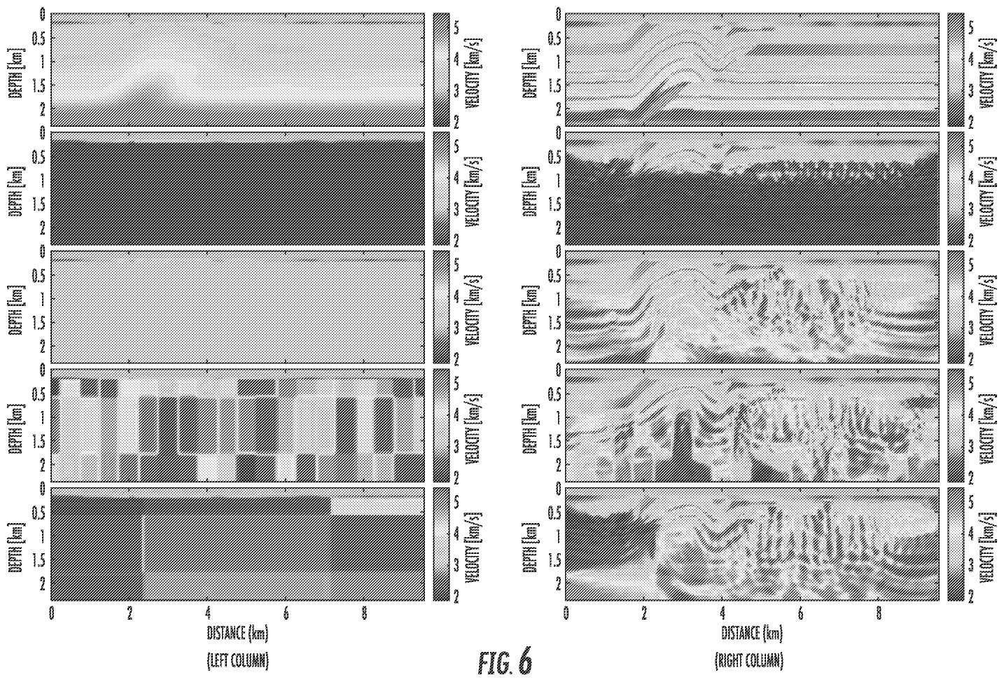

The disclosed hybrid optimization FWI method is demonstrated on the 2D Overthrust model, shown in FIG. 5. The FWI is tested in the acoustic setting where only the P-wave velocity is treated as the model parameter. The true model comprises a grid of 256×64 in x and z directions with a grid spacing of 0.0375 km. A Ricker wavelet with the peak frequency of 12 Hz is used as the source. Each shot has 256 receivers covering the entire surface simulating a land acquisition.

In FIG. 6, the left column shows five different starting models designed to test the sensitivity of different FWI methods to the different starting points. Two homogeneous models are chosen to either underestimate or overestimate the major parts of the true model. Two random models are drawn to be far away from the true model. These four models are deliberately selected to fail the traditional local optimization based FWI. First, the local optimization method is employed to perform the traditional local optimization FWI started from the five starting models until the data misfit cannot be further reduced. The inversion results are shown in the right column of FIG. 6. As expected, the test started with the smoothed version of the true model is able to accurately recover the velocity model. Other tests fail to render meaningful results due to getting stuck at one of the local minimum in the parameter space.

The disclosed method is employed using the starting models except for the smoothed version of the true model. To perform the disclosed method, the model parameters are discretized to 200×50 grid points with a grid spacing of 0.05 km in both x and z directions. So, a total of 10,000 model parameters are considered in this FWI, which is a relatively large number of parameters for commonly used global optimization methods. Because the disclosed method explores the parameter space with some degree of randomness, it would typically require more iterations to render a good result. To reduce the computational cost, only 10 shots were used in each iteration to evaluate E(m) and the gradient for this example. The gradient is preconditioned by the illumination operator. Because of the randomness introduced by the VFSA update, the Laplace operator is used to penalize the randomness in the model update. 3,000 iterations were run for each test and the inversion results are plotted in the left column of FIG. 7. Although the inversion results show some degree of fluctuations due to the introduced randomness, the major subsurface structures are successfully retrieved. The results are smoothed with a Gaussian filter with σ=0.03 km. Local optimization FWI is then run from the smoothed results to further refine the model and to improve the spatial resolution. The corresponding results are shown in the right column of FIG. 7. It is clear that the final inversion results all resemble the true model very well, except for the bottom corners where there is little data coverage.

### SEAM Salt Model

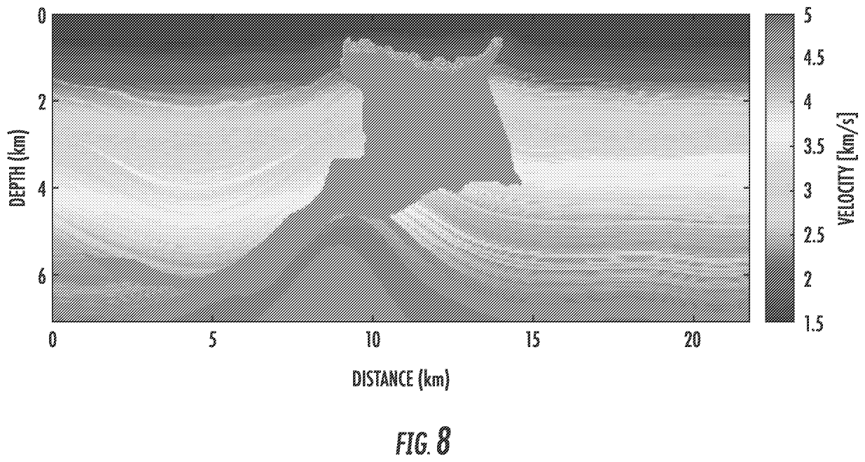

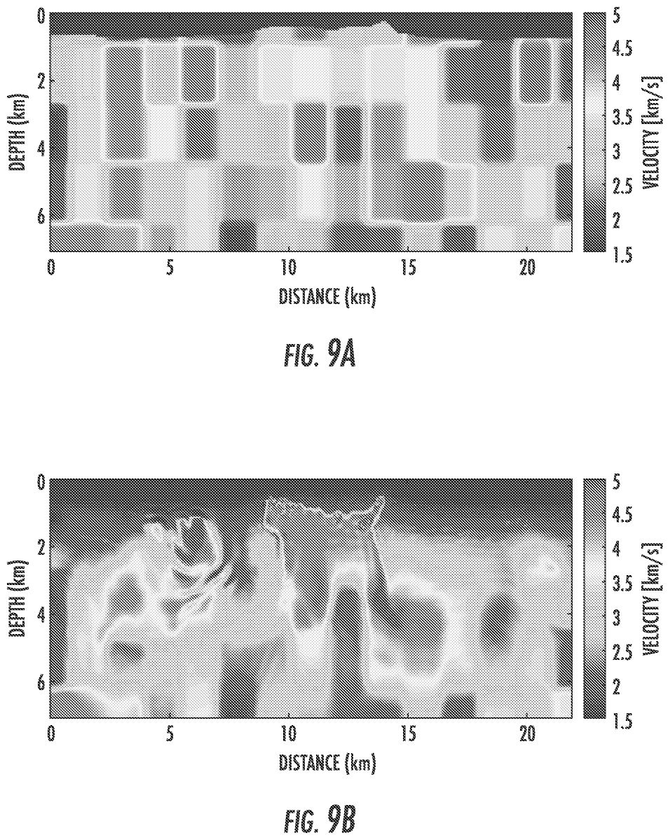

The 2D SEAM salt model is also employed to demonstrate the effectiveness of the disclosed method in the salt environment. The true model, shown in FIG. 8, comprises of 439×143 grid points with a grid spacing of 0.05 km in both x and z directions. A Ricker wavelet with the peak frequency of 4 Hz is used as the source. Each shot has 439 receivers covering the entire surface. A randomly drawn velocity model with the water column replaced by the true water velocity, shown in FIG. 9A, is used as the starting model for the following tests. The local optimization based FWI result is shown in FIG. 9B. The top part of the salt and the sediment layers on its right are partially retrieved. However, other parts of the model are not recovered, imprints of the starting model can be seen in the inversion result. The inversion is trapped at one of the local minima.

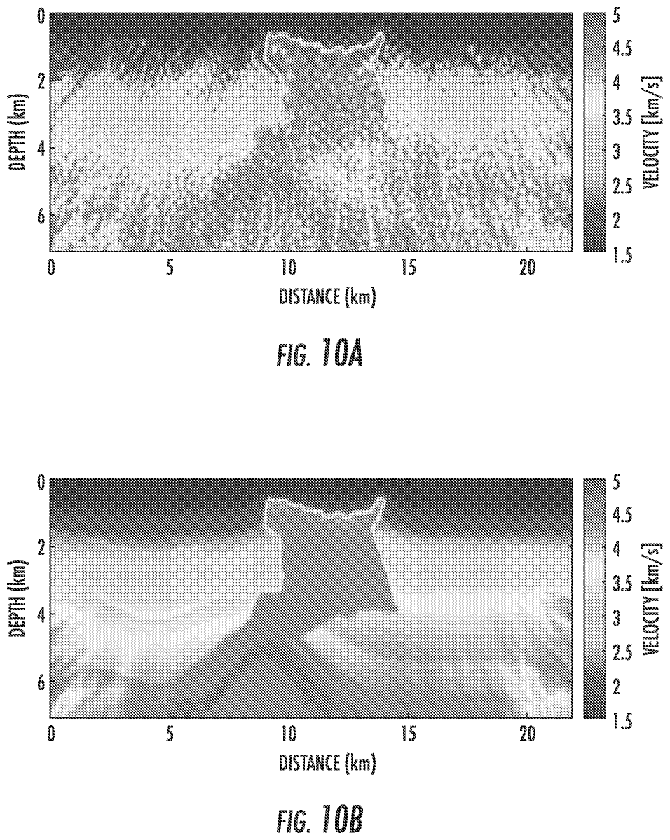

The disclosed method is then applied using the random starting model. The model is discretized to 220×71 grid points with a grid spacing of 0.1 km in both x and z directions. Again, the gradient is preconditioned by the illumination operator, and the Laplace operator is used to penalize the randomness in the model update. 5,000 iterations are run to obtain the inversion result shown in FIG. 10A. 6 shots are used in each iteration to reduce the computational cost. The result, smoothed with a Gaussian filter with σ=0.1 km, is then used as the starting model for a subsequent local optimization based FWI. The final result is plotted in FIG. 10B. The salt structure and sediment layers are correctly retrieved, except for the bottom corners of the model.

### Computing Environment

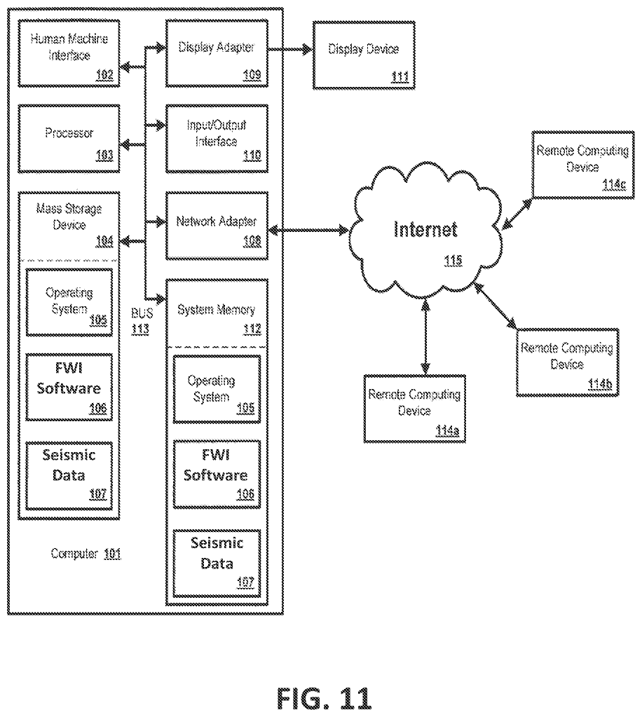

The system has been described above as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer 101 as illustrated in FIG. 11 and described below.

FIG. 11 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, FWI software 106, seismic data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as prediction data 107 and/or program modules such as operating system 105 and FWI software 106 that are immediately accessible to and/or are presently operated on by the processing unit 103.

In another aspect, the computer 101 can also comprise other removable/non-removable, volatile/non-volatile computer storage media. By way of example, FIG. 10 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and FWI software 106. Each of the operating system 105 and FWI software 106 (or some combination thereof) can comprise elements of the programming and the FWI software 106. Seismic data 107 can also be stored on the mass storage device 104. Seismic data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a key board, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of the prediction software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### REFERENCES

Throughout this application, various publications may be referenced. The disclosures of these publications in their entireties are hereby fully incorporated by reference into this application in order to more fully describe the state of the art to which the methods and systems pertain. The below publications are each fully incorporated by reference and made a part hereof:

Biondi, B., and A. Almomin, 2014, Simultaneous inversion of full data bandwidth by tomographic full-waveform inversion: Geophysics, 79, WA129-WA140.

Bunks, C., F. M. Saleck, S. Zaleski, and G. Chavent, 1995, Multiscale seismic waveform inversion: Geophysics, 60, 1457-1473.

Chunduru, R. K., M. K. Sen and P. L. Stoffa, 1997, Hybrid optimization methods for geophysical inversion: Geophysics, 62, no. 4, P1196-P1207.

Datta, D., and M. K. Sen, 2016, Estimating a starting model for full-waveform inversion using a global optimization method: Geophysics, 81, R211-R223.

Engquist, B., and B. D. Froese, 2013, Application of the Wasserstein metric to seismic signals: arXiv preprint arXiv: 1311.4581.

Fang, Z., C. Da Silva, R. Kuske, and F. J. Herrmann, 2018, Uncertainty quantification for inverse problems with weak partial-differential-equation constraints: Geophysics, 83, no. 6, R629-R647.

Ingber, L., 1989, Very fast simulated re-annealing: Mathematical and computer modelling, 12, 967-973.

Lailly, P., 1983, The seismic inverse problem as a sequence of before stack migrations, in Conference on Inverse Scattering, Theory and application, Expanded Abstracts: Society for Industrial and Applied Mathematics, 206-220.

Me'tivier, L., R. Brossier, Q. Merigot, E. Oudet, and J. Virieux, 2016, An optimal transport approach for seismic tomography: Application to 3D full waveform inversion: Inverse Problems, 32, no. 11, 115008.

Mishra, P. K., A. Arnulf, M. K. Sen, B. Denel, Y. Sun, and P. Williamson, 2020, Probabilistic joint-inversion of marine csem and seismic traveltime data using vfsa and generalized fuzzy clustering, in SEG Technical Program Expanded Abstracts 2020: Society of Exploration Geophysicists, 545-549.

Mulder, W., and R.- E. Plessix, 2008, Exploring some issues in acoustic full waveform inversion: Geophysical Prospecting, 56, 827-841.

Pratt, R. G., C. Shin, and G. Hick, 1998, Gauss-Newton and full Newton methods in frequency-space seismic waveform inversion: Geophysical Journal International, 133, no. 2, 341-362.

Porsani, M. J., P. L. Stoffa, M. K. Sen, R. K. Chunduru and W. T. Wood, 1993, A combined genetic and linear inversion algorithm for seismic waveform inversion, in SEG Technical Program Expanded Abstracts 1993: Society of Exploration Geophysicists, 692-695

Ravaut, C., S. Operto, L. Improta, J. Virieux, A. Herrero, and P. Dell'Aversana, 2004, Multiscale imaging of complex structures from multifold wide-aperture seismic data by frequency-domain full-waveform tomography: Application to a thrust belt: Geophysical Journal International, 159, no. 3, 1032-1056.

Sambridge, M., and K. Mosegaard, 2002, Monte Carlo methods in geophysical inverse problems: Reviews of Geophysics, 40, no. 3, 3-1-3-29.

Santosa, F., W. Symes, and G. Raggio, 1987, Inversion of band-limited reflection seismograms using stacking velocities as constraints: Inverse Problems, 3, no. 3, 477-499.

Sen, M. K., and P. L. Stoffa, 1991, Nonlinear one-dimensional seismic waveform inversion using simulated annealing: Geophysics, 56, no. 10, 1624-1638.

______, 2013, Global optimization methods in geophysical inversion: Cambridge University Press.

Shipp, R. M., and S. C. Singh, 2002, Two-dimensional full wavefield inversion of wide-aperture marine seismic streamer data: Geophysical Journal International, 151, no. 2, 325-344.

Sirgue, L., and R. G. Pratt, 2004, Efficient waveform inversion and imaging: A strategy for selecting temporal frequencies: Geophysics, 69, no. 1, 231-248.

Symes, W. W., 2008, Migration velocity analysis and waveform inversion: Geophysical prospecting, 56, 765-790.

Tape, C., Q. Liu, A. Maggi, and J. Tromp, 2010, Seismic tomography of the southern California crust based on spectral-element and adjoint methods: Geophysical Journal International, 180, no. 1, 433-462.

Tarantola, A., 1984, Inversion of seismic reflection data in the acoustic approximation: Geophysics, 49, no. 8, 1259-1266.

______, 2005, Inverse problem theory and methods for model parameter estimation: SIAM.

Virieux, J., and S. Operto, 2009, An overview of full-waveform inversion in exploration geophysics: Geophysics, 74, no. 6, WCC1-WCC26.

Warner, M., and L. Guasch, 2016, Adaptive waveform inversion: Theory: Geophysics, 81, no. 6, R429-R445.

Wu, R.-S., J. Luo, and B. Wu, 2014, Seismic envelope inversion and modulation signal model: Geophysics, 79, no. 3, WA13-WA24.

Xue, Z., N. Alger, and S. Fomel, 2016, Full-waveform inversion using smoothing kernels, in SEG Technical Program Expanded Abstracts 2016: Society of Exploration Geophysicists, 1358-1363.

Zhao, Z., and M. K. Sen, 2019, A multi-scale full waveform inversion method—staging wavenumber components and layer-stripping, in SEG Technical Program Expanded Abstracts 2019: Society of Exploration Geophysicists, 1470-1474.

______, 2021, A gradient-based markov chain monte carlo method for full-waveform inversion and uncertainty analysis: Geophysics, 86, R15-R30.

Zhu, H., and S. Fomel, 2016, Building good starting models for full-waveform inversion using adaptive matching filtering misfit: Geophysics, 81, no. 5, U61-U72.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A computer-implemented method for full-wavefield inversion of measured geophysical data to determine a velocity model for a subsurface region, comprising:
a) receiving seismic data for the subsurface region;
b) pre-processing the received seismic data;
c) generating a simple starting model;
d) generating synthetic seismic data using full-waveform inversion (FWI) based on the starting model;
e) computing an objective function by comparing the synthetic seismic data with pre-processed observed data;
f) computing a gradient of the objective function with respect to subsurface model parameters;
g) if one or more defined stopping parameters are not met, then updating the starting model with the gradient, a random perturbation term, and a regularization term and going back to step d); or
h) if the one or more defined stopping parameters are met, then outputting a final velocity model for the subsurface region.

2. The method of claim 1, wherein the starting model comprises a homogenous model or randomly generated model.

3. The method of claim 1, wherein the starting model comprises a model derived based on prior well-log information or a tomographic model.

4. The method of claim 1, wherein the stopping parameters are based on a small mismatch value between the synthetic seismic data or a number of times that steps d)-g) are iteratively performed.

5. The method of claim 1, wherein generating synthetic seismic data using FWI based on the starting model comprises estimating synthetic seismic data using a seismic wave simulator by solving two-way wave equations for multiple source locations.

6. The method of claim 1, wherein computing an objective function by comparing the synthetic seismic data with pre-processed observed data comprises calculating the objective function defined by
$$\\ E ( m ) = \frac{1}{2} {‖ {d}_{obs} - {d}_{est} ‖}_{2} ,$$

7. The method of claim 6, wherein computing the gradient of the objective function with respect to subsurface model parameters comprises computing the gradient of the objective function with respect to model parameters at each inversion grid (model parameter i) by solving two way wave equations for multiple source locations with multiple times using an adjoint-state method.

8. The method of claim 7, wherein determining if one or more defined stopping parameters are not met, and then updating the starting model with the gradient, a random perturbation term, and a regularization term and going back to step d) comprises:
i. Loop over numbers of random moves within the current temperature:
1. for each model parameter i
a. Draw random number uᵢ from a uniform distribution ranging from [0 1]
b. Get yᵢ according to
$$\\ {y}_{i} = sgn ( {u}_{i} - \frac{1}{2} ) {T}_{i}^{{}_{} new} [ {( 1 + \frac{1}{{T}_{i}^{{}_{} new}} )}^{\vert 2 {u}_{i} - 1 \vert} - 1 ]$$
c. Update model parameter mᵢ using mᵢ(new)<=mᵢ(old)−α*gᵢ+yᵢ(Δm)+Dᵢ (where α is the step length, gᵢ is the gradient term, and Dᵢ is the regularization term)
d. Decide if mᵢ(new) is within the range of mᵢ_max and mi_min, if so, continue to below 2., if not, go back to step a Draw random number. . . .
2. Compute the difference between the objective function of the old model and the objective function of the new model, ΔE
3. Compute P=exp(−ΔE/Tₖ), where Tₖ is the current temperature
4. If ΔE<=0, then
a. Accept the new model
i. Replace the current model with the new model
ii. Replace the current objective function with the new objective function
iii. Replace the current gradient with the new gradient
5. else if ΔE>0, then
a. Draw a random number r from a uniform distribution ranging from [0 1]
b. If P>r, then
i. Accept the new model
1. Replace the current model with the new model
2. Replace the current objective function with the new objective function
3. Replace the current gradient with the new gradient
c. Else if P<=r, then
i. Reject the new model
1. Keep the current model
2. Keep the current objective function
3. Keep the current gradient
ii. End the iterative loop of ‘i’ if the numbers of random move within the current temperature is finished.
iii.

[symbol]

9. The method of claim 8, wherein the stopping criteria comprises the cooling schedule reaching an end or ΔE is smaller than a user defined value.

10. A computer-implemented method for full-wavefield inversion of measured geophysical data to determine a velocity model for a subsurface region, comprising:
a. Initiating a seismic source at multiple locations
b. Recording/receiving seismic reflection and refraction signals from the subsurface
c. Pre-processing recorded data by removing noises
d. Generating a simple starting model
e. Iteratively executing the following steps
i. Generating the current temperature Tₖ according to a user defined cooling schedule at the current iteration k, the temperature Tₖ is obtained with Tₖ=T₀exp(−c*k^{0.5}) where T₀ is the starting temperature and c is the temperature decay factor
1. Estimating synthetic seismic data using seismic wave simulator by solving two-way wave equations for multiple source locations
2. Calculating objective function defined by
$$\\ E ( m ) = \frac{1}{2} {‖ {d}_{obs} - {d}_{est} ‖}_{2} ,$$
3. Computing a gradient of the objective function with respect to model parameter at each inversion grid (model parameter i) by solving two way wave equations for multiple source locations with multiple times using an adjoint-state method
4. Looping over numbers of random moves within the current temperature:
a. for each model parameter i
i. Draw random number uᵢ from a uniform distribution ranging from [0 1]
ii. Get yᵢ according to
$$\\ {y}_{i} = sgn ( {u}_{i} - \frac{1}{2} ) {T}_{i}^{{}_{} new} [ {( 1 + \frac{1}{{T}_{i}^{{}_{} new}} )}^{\vert 2 {u}_{i} - 1 \vert} - 1 ]$$
iii. Update model parameter mi using mᵢ(new)<=mᵢ(old)−α*gᵢ+yᵢ(Δm)+Dᵢ (where α is the step length, gᵢ is the gradient term, and Dᵢ is the regularization term)
iv. Decide if mᵢ(new) is within the range of mᵢ_max and mi_min, if so, continue to below 2., if not, go back to step a Draw random number. . . .
b. Computing the difference between the objective function of the old model and the objective function of the new model, ΔE
c. Computing P=exp(−ΔE/Tₖ), where Tₖ is the current temperature
d. If ΔE<=0, then
i. Accept the new model
1. Replace the current model with the new model
2. Replace the current objective function with the new objective function
3. Replace the current gradient with the new gradient
e. else if ΔE>0, then
i. Draw a random number r from a uniform distribution ranging from [0 1]
ii. If P>r, then
1. Accept the new model
a. Replace the current model with the new model
b. Replace the current objective function with the new objective function
c. Replace the current gradient with the new gradient
iii. Else if P<=r, then
1. Reject the new model
a. Keep the current model
b. Keep the current objective function
c. Keep the current gradient
5. End the iterative loop of ‘iv’ if the numbers of random move within the current temperature is finished
ii. End the iterative loop of ‘a’ if the cooling schedule reach the end or ΔE is smaller than a user defined value (the stopping criteria)
f. Outputting the final model for predicting subsurface structures.

11. The method of claim 1, wherein the final velocity model for the subsurface region is used to develop a drilling plan and wellbore parameters for the subsurface region.

12. The method of claim 11, wherein the final velocity model for the subsurface region is used to identify a plurality of well paths in the subsurface region; determine a casing plan and mud weight long each of the well paths; and select an optimal well path from among the plurality of well paths, wherein the optimal well path is selected based on one or more of cost, safety and stability of the well path.

13. A system for full-wavefield inversion of measured geophysical data to determine a velocity model for a subsurface region, comprising:
a memory in communication with a processor, wherein computer-executable instructions stored on the memory when executed by the processor cause the processor to:
a) receive seismic data for the subsurface region;
b) pre-process the received seismic data;
c) generate a simple starting model;
d) generate synthetic seismic data using full-waveform inversion (FWI) based on the starting model;
e) compute an objective function by comparing the synthetic seismic data with pre-processed observed data;
f) compute a gradient of the objective function with respect to subsurface model parameters;
g) if one or more defined stopping parameters are not met, then update the starting model with the gradient, a random perturbation term, and a regularization term and go back to step d); or
h) if the one or more defined stopping parameters are met, then output a final velocity model for the subsurface region.

14. The system of claim 13, wherein the starting model comprises a homogenous model or randomly generated model.

15. The system of claim 13, wherein the starting model comprises a model derived based on prior well-log information or a tomographic model.

16. The system of claim 13, wherein the stopping parameters are based on a small mismatch value between the synthetic seismic data or a number of times that steps d)-g) are iteratively performed.

17. The system of claim 13, wherein generating synthetic seismic data using FWI based on the starting model comprises estimating synthetic seismic data using a seismic wave simulator by solving two-way wave equations for multiple source locations.

18. The system of claim 13, wherein computing an objective function by comparing the synthetic seismic data with pre-processed observed data comprises calculating the objective function defined by
$$\\ E ( m ) = \frac{1}{2} {‖ {d}_{obs} - {d}_{est} ‖}_{2} ,$$

19. The system of claim 18, wherein computing the gradient of the objective function with respect to subsurface model parameters comprises computing the gradient of the objective function with respect to model parameters at each inversion grid (model parameter i) by solving two way wave equations for multiple source locations with multiple times using an adjoint-state method.

20. The system of claim 19, wherein determining if one or more defined stopping parameters are not met, and then updating the starting model with the gradient, a random perturbation term, and a regularization term and going back to step d) comprises:
iv. Loop over numbers of random moves within the current temperature:
1. for each model parameter i
a. Draw random number uᵢ from a uniform distribution ranging from [0 1]
b. Get yᵢ according to
$$\\ {y}_{i} = sgn ( {u}_{i} - \frac{1}{2} ) {T}_{i}^{{}_{} new} [ {( 1 + \frac{1}{{T}_{i}^{{}_{} new}} )}^{\vert 2 {u}_{i} - 1 \vert} - 1 ]$$
c. Update model parameter mᵢ using mᵢ(new)<=mᵢ(old)−α*gᵢ+yᵢ(Δm)+Dᵢ (where α is the step length, gᵢ is the gradient term, and Dᵢ is the regularization term)
d. Decide if mᵢ(new) is within the range of mᵢ_max and mi_min, if so, continue to below 2., if not, go back to step a Draw random number. . . .
2. Compute the difference between the objective function of the old model and the objective function of the new model, ΔE
3. Compute P=exp(−ΔE/Tₖ), where Tₖ is the current temperature
4. If ΔE<=0, then
a. Accept the new model
i. Replace the current model with the new model
ii. Replace the current objective function with the new objective function
iii. Replace the current gradient with the new gradient
5. else if ΔE>0, then
a. Draw a random number r from a uniform distribution ranging from [0 1]
b. If P>r, then
i. Accept the new model
1. Replace the current model with the new model
2. Replace the current objective function with the new objective function
3. Replace the current gradient with the new gradient
c. Else if P<=r, then
i. Reject the new model
1. Keep the current model
2. Keep the current objective function
3. Keep the current gradient
v. End the iterative loop of ‘i’ if the numbers of random move within the current temperature is finished

21. The system of claim 20, wherein the stopping criteria comprises the cooling schedule reaching an end or ΔE is smaller than a user defined value.

22. A computer-implemented system for full-wavefield inversion of measured geophysical data to determine a velocity model for a subsurface region, comprising:
a memory in communication with a processor, wherein computer-executable instructions stored on the memory when executed by the processor cause the processor to:
a. Initiate seismic source at multiple locations
b. Record/receive seismic reflection and refraction signals from the subsurface
c. Pre-process recorded data by removing noises
d. Generate a simple starting model
e. Iteratively execute following steps
a. Generate the current temperature Tₖ according to a user defined cooling schedule at the current iteration k, the temperature Tₖ is obtained with Tₖ=T₀exp(−c*k^{0.5}) where T₀ is the starting temperature and c is the temperature decay factor
1. Estimate synthetic seismic data using seismic wave simulator by solving two-way wave equations for multiple source locations
2. Calculate objective function defined by
$$\\ E ( m ) = \frac{1}{2} {‖ {d}_{obs} - {d}_{est} ‖}_{2} ,$$
3. Compute gradient of the objective function with respect to model parameter at each inversion grid (model parameter i) by solving two way wave equations for multiple source locations with multiple times using the adjoint-state method
4. Loop over numbers of random moves within the current temperature:
a. for each model parameter i
i. Draw random number uᵢ from a uniform distribution ranging from [0 1]
ii. Get yᵢ according to
$$\\ {y}_{i} = sgn ( {u}_{i} - \frac{1}{2} ) {T}_{i}^{{}_{} new} [ {( 1 + \frac{1}{{T}_{i}^{{}_{} new}} )}^{\vert 2 {u}_{i} - 1 \vert} - 1 ]$$
iii. Update model parameter mᵢ using mᵢ(new)<=mᵢ(old)−α*gᵢ+yᵢ(Δm)+Dᵢ (where α is the step length, gᵢ is the gradient term, and Dᵢ is the regularization term)
iv. Decide if mᵢ(new) is within the range of mᵢ_max and mi_min, if so, continue to below 2., if not, go back to step a Draw random number. . . .
b. Compute the difference between the objective function of the old model and the objective function of the new model, ΔE
c. Compute P=exp(−ΔE/Tₖ), where Tₖ is the current temperature
d. If ΔE<=0, then
i. Accept the new model
1. Replace the current model with the new model
2. Replace the current objective function with the new objective function
3. Replace the current gradient with the new gradient
e. else if ΔE>0, then
i. Draw a random number r from a uniform distribution ranging from [0 1]
ii. If P>r, then
1. Accept the new model
a. Replace the current model with the new model
b. Replace the current objective function with the new objective function
c. Replace the current gradient with the new gradient
iii. Else if P<=r, then
1. Reject the new model
a. Keep the current model
b. Keep the current objective function
c. Keep the current gradient
5. End the iterative loop of ‘iv’ if the numbers of random move within the current temperature is finished
ii. End the iterative loop of ‘a’ if the cooling schedule reach the end or ΔE is smaller than a user defined value (the stopping criteria)
f. Output the final model for predicting subsurface structures.

23. The system of claim 13, wherein the final velocity model for the subsurface region is used to develop a drilling plan and wellbore parameters for the subsurface region.

24. The system of claim 23, wherein the final velocity model for the subsurface region is used to identify a plurality of well paths in the subsurface region; determine a casing plan and mud weight long each of the well paths; and select an optimal well path from among the plurality of well paths, wherein the optimal well path is selected based on one or more of cost, safety and stability of the well path.
